(19) United States
(12) Patent Application Publication
(10) Pub. No.: US 2022/0277469 A1
(43) Pub. Date: Sep. 1, 2022

(54) SCENE RETRIEVAL FOR COMPUTER VISION

(71) Applicant: INTEL CORPORATION, Santa Clara, CA (US)

(72) Inventor: Bin WANG, BEIJING (CN)

(73) Assignee: INTEL CORPORATION, Sant Clara, CA (US)

(21) Appl. No.: 17/637,572

(22) PCT Filed: Sep. 23, 2019
(86) PCT No.: PCT/CN2019/107230

§ 371 Date: Feb. 23, 2022

(51) Int. Cl. G06T 7/70; G06V 10/46; G06V 10/82; G06N 3/04

(52) U.S. Cl. CPC G06T 7/70; G06V 10/46; G06V 10/82; G06N 3/0481

(57) ABSTRACT

Systems, methods, computer program products, and apparatuses for scene retrieval are provided. Images can be captured with a depth camera and image data encoded with both color and depth indications. A convolutional neural network comprising a fast channel wide block is provided. Image descriptors can be extracted from the images based on output from the fast channel wide block. Such image descriptors can be used to retrieve scenes from a SLAM process for purposes of localization.

### BACKGROUND

Navigation within the field of robotics includes many challenges. One such challenge is determining the location of the robot. Often, robots will include sensors, cameras, associated processing circuitry, and other hardware to implement some type of simultaneous localization and mapping (SLAM) algorithm.

### BRIEF DESCRIPTION OF THE DRAWINGS

FIG. 1 illustrates a scene retrieval computing device.

FIG. 2 illustrates a robotic system comprising a scene retrieval computing device.

FIG. 3 illustrates a first logic flow for scene retrieval based on a convolutional neural network (CNN) including a fast channel wide block (FCWB).

FIG. 4 illustrates a convolutional neural network (CNN) including a fast channel wide block (FCWB).

FIG. 5 illustrates a fast channel wide block (FCWB).

FIG. 6 illustrates a second logic flow for scene retrieval based on a convolutional neural network (CNN) including a fast channel wide block (FCWB).

FIG. 7 illustrates an embodiment of a storage medium.

FIG. 8 illustrates an embodiment of a system.

### DETAILED DESCRIPTION

In general, the present disclosure can provide for scene retrieval. Said differently, systems can implement the present disclosure to provide for retrieval of scenes, or images, which can be provided in conjunction with a mapping, localization, path-planning, and/or object recognition process. Often, robotics systems map an environment through images. In such an example, the robotics system, or a portion of the robotics system, can provide location tracking or location detection within the environment based on scene retrieval implemented according to the present disclosure.

The present disclosure provides processing circuitry arranged to receive images from a camera where the image comprises both color and depth information. The processing circuitry can extract features of the image based on a convolutional neural network (CNN). More particularly, output from intermediate layers of the CNN can be used as image feature descriptors. These image feature descriptors from the currently received image as compared with image feature descriptors from images of the known environments, such as, for example, images captured during mapping based on a SLAM algorithm.

During operation, processing circuitry can receive data associated with an image captured by a depth camera. For example, the data comprises indications of color and depth. With some examples, the color information can be represented using three channels (e.g., RGB) while the depth information can also be represented suing three channel (e.g., horizontal disparity, height above ground, and normal angle (HHA)) resulting in a 6-channel image. This 6-channel image is input into a CNN that includes a fast channel wise block (FCWB). The output from the FCWB can be used to retrieve scenes, or said differently, match the currently captured scene to a previously identified scene, for example, to supplement a localization process.

The present disclosure further provides the FCWB to extract the image feature descriptors from the CNN. Further, it is worth noting that the present disclosure provides a number of advantages over conventional approaches to scene retrieval. For example, the present disclosure provides the above noted FCWB. Additionally, the present disclosure provides that the input image comprises both color (e.g., red, green, blue (RGB) color components) and depth indications.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that these and similar terms are to be associated with the appropriate physical quantities and are merely convenient labels applied to those quantities.

Further, these manipulations may be referred to in terms, such as adding or comparing, which are commonly associated with logical operations. Useful machines for performing these logical operations may include general purpose digital computers as selectively activated or configured by a computer program that is written in accordance with the teachings herein, and/or include apparatus specially constructed for the required purpose. Various embodiments also relate to apparatus or systems for performing these operations. These apparatuses may be specially constructed for the required purpose or may include a general-purpose computer. The required structure for a variety of these machines will be apparent from the description given.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well known structures and devices are shown in block diagram form to facilitate a description thereof. The intention is to cover all modification, equivalents, and alternatives within the scope of the claims.

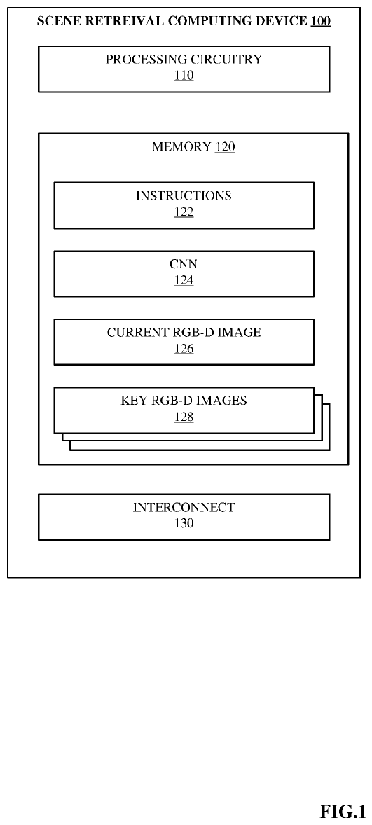

FIG. 1 illustrates an embodiment of a scene retrieval computing device 100. The scene retrieval computing device 100 is representative of any number and type of processing devices, arranged to retrieve a scene, or said differently, to match a current captured image to one of a number of known image for purposes of scene retrieval and/or localization.

The scene retrieval computing device 100 includes processing circuitry 110, memory 120, and interconnect 130. The processing circuitry 110 may include circuity or digital logic arranged to processing instructions. For example, processing circuitry 110 may be any of a variety of commercial processors. In n some instances, processor is used synonymously with processing circuitry. For example, some descriptions herein use processor 110 instead of processing circuitry 110 without limiting the scope of the claims. In some examples, the processor 110 may include multiple processors, a multi-threaded processor, a multi-core processor (whether the multiple cores coexist on the same or separate dies), and/or a multi-processor architecture of some other variety by which multiple physically separate processors are in some way linked. Additionally, in some examples, the processing circuitry 110 may include graphics processing portions and may include dedicated memory, multiple-threaded processing and/or some other parallel processing capability. In some examples, the processing circuitry 110 may be an application specific integrated circuit (ASIC) or a field programmable integrated circuit (FPGA). In some implementations, the processing circuitry 110 may be circuitry arranged to perform computations related to artificial intelligence (AI), sometimes referred to as an accelerator, or AI accelerator.

The memory 120 may include circuitry, a portion of which includes arrays of integrated circuits, forming non-volatile memory to persistently store data or a combination of non-volatile memory and volatile memory. It is to be appreciated, that memory 120 may be based on any of a variety of technologies. In particular, the arrays of integrated circuits included in memory 120 may be arranged to form one or more types of memory, such as, for example, dynamic random access memory (DRAM), NAND memory, NOR memory, or the like.

Interconnect 130 may include logic and/or features to support a communication interface. For example, the interconnect 130 may include one or more interconnects that operate according to various communication protocols or standards to communicate over direct or network communication links. Direct communications may occur via use of communication protocols or standards described in one or more industry standards (including progenies and variants). For example, the interconnect 130 may facilitate communication over a bus, such as, for example, peripheral component interconnect express (PCIe), non-volatile memory express (NVMe), universal serial bus (USB), system management bus (SMBus), SAS (e.g., serial attached small computer system interface (SCSI)) interfaces, serial AT attachment (SATA) interfaces, a wired network interconnect, or the like. In some examples, interconnect 130 may be arranged to support wireless communication protocols or standards, such as, for example, Wi-Fi, Bluetooth, ZigBee, LTE, 5G, or the like.

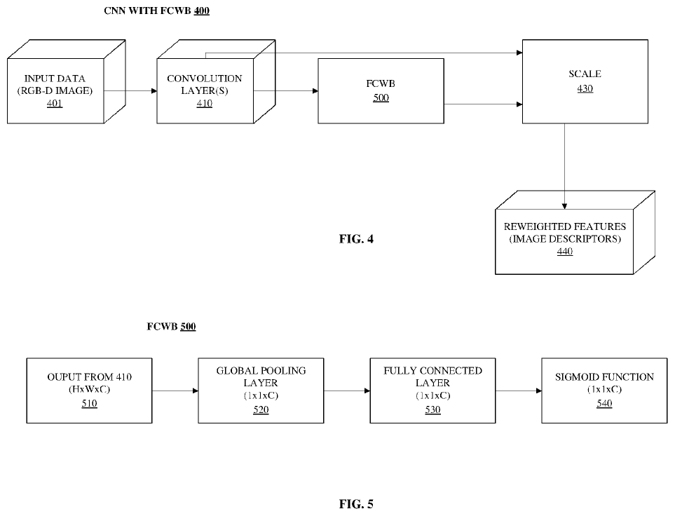

Memory 120 stores instructions 122, as well a CNN 124, a current RGB-D image 126, and a number of key RGB-D images 128. In general, CNN 124 includes a number of layer as well as a FCWB, for example, as depicted in FIGS. 4 and 5. Processing circuitry 110 can execute instructions 122 to match RGB-D image 126 to one of the key RGB-D images 128 to retrieve a scene. For example, processing circuitry 110 can execute instructions 122 to match RGB-D image 126 to one of the key RGB-D images 128 to retrieve a scene as part of a SLAM algorithm. This is described in greater detail below.

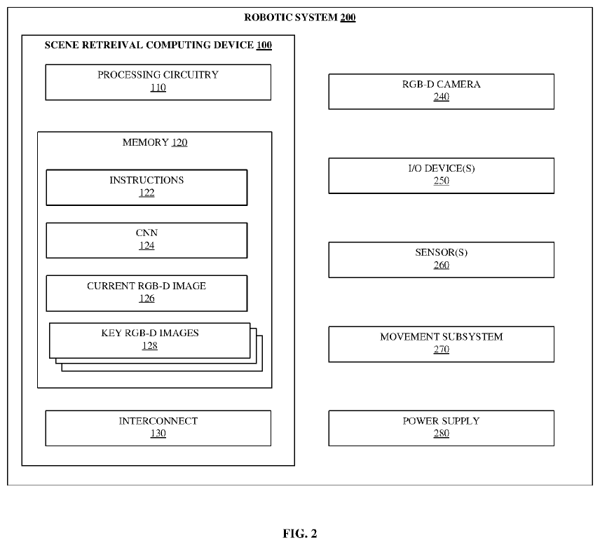

FIG. 2 illustrates an example robotic system 200 that includes the scene retrieval computing device 100 of FIG. 1. The robotic system 200 further includes an RGB-D camera 240, I/O device(s) 250, sensor(s) 260, movement subsystem 270, and power subsystem 280. In general, RGB-D camera 240 can be any of a variety of image capture devices arranged to provide both color and depth information associated with a captured image. For example, RGB-D camera 240 can comprise one or more image sensors and one or more depth sensors. As a specific example, the RGB-D camera 240 can comprise an infrared (IR) projector, an infrared sensors, and an RGB sensor. In more complex examples, the RGB-D camera can comprise pairs of depth and/or image sensors. In general, however, the RGB-D camera is arranged to capture an image and output data comprising indications of the captured image where the data includes information on both the color and depth of the image captured.

Processing 110, in executing instructions 122, can receive (e.g., via interconnect 130, or the like) data associated with the captured image and can store the data as RGB-D image 126. With some examples, the RGB-D image 126 can include indications of both color and depth for each pixel represented in the image. For example, the RGB-D image 126 can include indications of RGB color components and HHA depth components of the captured image, represented in 6 channels. Said differently, RGB-D image 126 can be an RGB-HHA encoded image.

I/O device(s) 250 can include any of a variety of devices providing input, output, or both input and output to the robotic system 200. For example, I/O devices 250 can include keyboards, trackpads, touch screens, microphones, displays, speakers, light emitting diodes (LEDs), or other devices with which a user can interact with the robotic device. Said differently, I/O devices 250 include any device arranged to provide input to the robotic device or receive output from the robotic device.

Sensor(s) 260 can include any of a variety of devices providing sensory input to the robotic system 200. For example, sensors 260 can include accelerometers, radar, LIDAR, magnetometers, global positioning systems (GPS), pressure sensors, thermal sensors, or other types of sensor or detectors.

Movement subsystem 270 can include any of a variety of hardware to provide mobility to the robotic system 200. With some examples, movement subsystem 270 can include wheels, motors, tracks, propellers, or other mobility devices along with associated controllers, processors, memory and instructions, etc. to provide mobility for the robotic system 200.

Power subsystem 280 can include any of a variety of devices arranged to supply power to the components of the robotic system 200. For example, power subsystem 280 can include batteries, power supplies, voltage regulators, circuit protection devices, charging circuitry, etc.

As noted, the present disclosure provides robotic system 200 arranged with a CNN having a FCWB where indications of image descriptors can be extracted from the FCWB by processing circuitry 110 of the robotic system 200. Such image descriptors may be used for localization as part of a SLAM algorithm. For example, robotic system 200 can capture key RGB-D images 128 during an initial mapping phase of the SLAM algorithm. As such key RGB-D images 128 can be tagged with an associated location (e.g., of an indoor environment, an outdoor environment, a hybrid indoor-outdoor environment, or the like) mapped as part of a SLAM process. Furthermore, robotic system 200 can store (e.g., in a database, or the like) image descriptors extracted from key RGB-D images 128 using the FCWB of CNN 124 as detailed herein. Subsequently, robotic system 200 can implement a localization processor where image descriptors are extracted from current RGB-D image 126 are extracted and a location is identified based in part on matching the extracted image descriptors from current RGB-D image 126 to image descriptors from a one of the key RGB-D images 128.

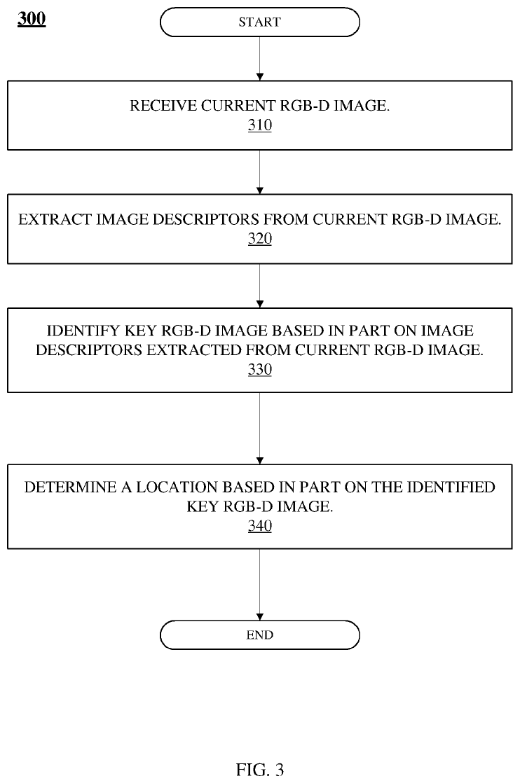

FIG. 3 illustrates a logic flow 300. The logic flow 300 may be representative of operation executed by processor 110 in executing instructions 122 to match a current RGB-D image to a key RGB-D image for localization, for example, as part of a SLAM algorithm.

Logic flow 300 can begin at block 310. At block 310 “receive a current RGB-D image” scene retrieval computing device 100 (e.g., as part of robotic system 200, or the like) can receive a current RGB-D image. For example, in executing instructions 122, processor 110 can receive indications of current RGB-D image 126. As another example, processor 110, in executing instructions 122, can receive data from RGB-D camera 240 comprising indications of current RGB-D image 126, including sending control signal(s) to RGB-D camera 240 to cause RGB-D camera 240 to capture an image.

Continuing top block 320 “extract image descriptor from current RGB-D image” scene retrieval computing device 100 can extract image descriptor from current RGB-D image 126. For example, in executing instructions 122 processor 110 can extract image features, or image descriptors, from current RGB-D image 126. This is described in greater detail below. However, in general, image descriptors can be extracted from the FCWB of the CNN 124.

Continuing to block 330 “identify key RGB-D image based in part on image descriptors extracted from current RGB-D image” computing device 100 can identify a one of the key RGB-D images 128 based on image descriptors extracted from current RGB-D image 126. For example, in executing instructions 122 processor 110 can match image descriptors extracted from current RGB-D image 126 with image descriptors from key RGB-D images 128 to identify a one (or ones) of the key RGB-D images 128. As a specific example, processor 110 in executing instructions 122 can match extracted features from current RGB-D image 126 with a one (or ones) of the key RGB-D image 128 based on an Oriented FAST and Rotated BRIEF (ORB) feature matching process.

Continuing to block 340 “identify a location based in part on the identified key RGB-D image” computing device 100 can identify a location based on the identified key RGB-D image. For example, in executing instructions 122 processor 110 can determine a location associated with the key RGB-D image 128 identified during block 330.

FIG. 4 illustrates an example CNN 400 including a processing block (e.g., a FCWB, or the like) while FIG. 5 illustrates an example processing block 500 (e.g., FCWB 500). It is noted, that the processing block 500 is referred to herein as a FCWB. However, examples are not limited in this context. FIGS. 4-5 along with CNN 400 and FCWB are described in parallel. Architecture of CNN 124 of device 100 and system 200 can be based on CNN 300 illustrated and described in this figure. In general, a CNN consists of convolutional and subsampling layers, and may also include fully connected layers. CNN 400 includes convolutional layers 410. The input to the convolutional layers 410 is an image comprising indications of both color and depth. For example, input data 401 is depicted, which can comprise an RGB-D image, such as, current RGB-D image 126, or ones of key RGB-D images 128. For purposes of explanation, input data 401 can be an Xx Y x R image where X and Y are the dimensions of the image data 401 (e.g., heights and width in pixels, or the like) and R is the number of channels. For example, for an RGB image, there are 3 channels, one each for the red, green, and blue pixel color data. Likewise, the present disclosure includes at least one channel for depth. However, often, depth can be provided with more than one channel, such as, for example, 3 channels. More specifically, R can be 6 where there are 3 channels for the RGB data and 3 channels for the HHA depth data. As a specific example, a single depth channel can be encoded to a 3-channel HHA representation (horizontal disparity, height above ground, and the angle of the local surface normal with the inferred gravity direction) as inputs. A benefit to such an encoding is that the HHA encoding carries more geometry cues than the original depth map (e.g., surface normal and height) and it provides symmetry between the color channels and the depth channels.

Generally, speaking, convolutional layer(s) 410 may have a number of filters having dimensions smaller than X×Y. The size of the filters gives rise to the locally connected structure which are each convolved with input data 401 produce a feature map.

CNN 400 further includes a FCWB 500. In general, the outputs 510 from each layer of the convolutional layer 410 (e.g., the feature map) are input to the FCWB 500. It is noted, that the CNN 400 of the present disclosure provides that instead of extracting image descriptors from the convolution outputs (e.g., from the feature map), reweighted features 440 are extracted based on outputs form the FCWB 500 and a scaling layer 430. The reweighted features 440 are the extracted image descriptors discussed herein.

Generally speaking, the FCWB 500 contains a global pooling layer 520 to abstract global spatial information, a fully connected layer 530 to estimate the dependencies of different feature maps, and a sigmoid function 540 to weight the importance of each channel.

Let, F_{c}^{m} denotes the features learned in M^{t}^{^{□}} layer of the convolutional layers 410, let c be the channel of the feature, and let W and H be the width and height of the features. Given this, the global pooling layer 520 can derive global pooling based on Equation 1.

$$F ( {F}_{c}^{m} ) = \frac{1}{H \times W} {\sum }_{i = 1}^{H} {\sum }_{j = 1}^{W} {F}_{c}^{m} \qquad [ 1 ]$$

Furthermore, the sigmoid function 540 can be derived based on Equation 2, where W_{f} is the parameters in the fully connected layer 530 and F is the result of the global pooling layer 520.

θ=f(w, α)=σ(W_{f}F)

As depicted, FCWB 500 is inserted into the CNN architecture 400. Accordingly, following each convolution, channel-wise weights can be used as a scale factor 430 for feature recalibration where F_{c}^{m}=F_{c}^{m}θ.

It is noted, that FCWB 500 can be inserted into conventional CNN architectures, such as, for example, VGG, GoogleNet, or the like. With some examples, FCWB 500 is inserted into CNN 400 after CNN 400 is trained. For example, CNN 400 can be trained to identify objects in images. Accordingly, given a robotic system with a set of key RGB-D images and associated locations, for example, generated as part of a SLAM process; CNN 400 can be used to localize, or that is, determine a location, of the robotic system given the key RGB-D images and a current RGB-D image.

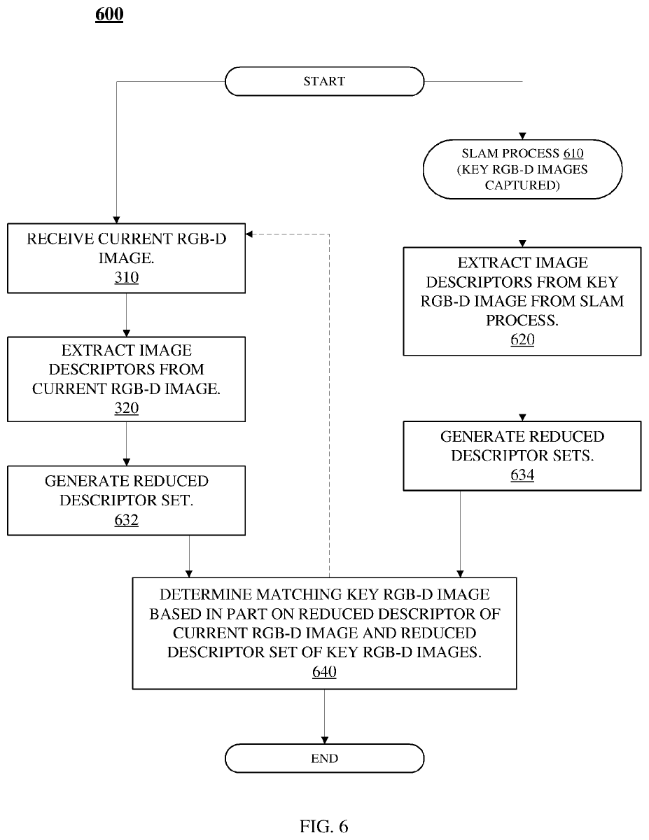

FIG. 6 illustrates a logic flow 600. The logic flow 600 may be representative of operation executed by processor 110 in executing instructions 122 to match a current RGB-D image to a key RGB-D image for localization, for example, as part of a SLAM algorithm. Logic flow 600 includes portions of logic flow 300, which are referenced here for convenience. Furthermore, logic flow 600 is arranged to operate, or be executed by a processor executing instructions arranged to implement operations to carry out logic flow 600 after a SLAM process has been implemented to capture a number of key RGB-D images 128.

Logic flow 600 can begin at blocks 310 and sub-flow SLAM process 610. Block 310 “receive a current RGB-D image” may be like as described above with respect to FIG. 3. SLAM process 610 can be any of a variety of SLAM process wherein key images are captured. For slam process 610, the images may be captured with a depth camera as detailed herein and the key images encoded to indicate both color and depth (e.g., using the 6-channel encoding detailed herein, or the like).

Continuing to block 320 and block 620. At block 320 “extract image descriptor from current RGB-D image” scene retrieval computing device 100 can extract image descriptor from current RGB-D image 126. For example, in executing instructions 122 processor 110 can extract image features, or image descriptors, from current RGB-D image 126. This is described in greater detail below. However, in general, image descriptors can be extracted from the FCWB of the CNN 124. Likewise, at block 620 “extract image descriptor from key RGB-D images from SLAM process” scene retrieval computing device 100 can extract image descriptors from key RGB-D images 128.

Continuing to block 632 “generate reduced descriptor set” and block 634 “generate reduced descriptor sets” computing device 100 can generate a reduced image descriptor set for the current RGB-D image 126 (e.g., at block 632) and reduced image descriptor sets for the key RGB-D images 128 (e.g., each of the kay images 128 may have a reduced image descriptor set). For example, in executing instructions 122 processor 110 can generate an reduced descriptor set for an image (e.g., current RGB-D image 126, key RGB-D image 128, etc.) comprising indications of image descriptors found extracted from the image that meet a certain threshold of confidence. For example, reduced descriptor sets can include indications of types of descriptors extracted from the images (e.g., object names, object heights, object orientations, etc.).

Continuing to block 640 “identify a one of the key RGB-D images matching the current RGB-D image based in part on the reduced descriptor sets” computing device 100 can identify one of the key RGB-D images 128, which matches the current RGB-D image 126 based on the reduced descriptor sets. As a specific example, processor 110 in executing instructions 122 can identify one of the key RGB-D images having a reduced descriptor set that matches (e.g., within a threshold level, or the like) that matches (e.g., based on an ORB feature matching process, or the like) the reduced descriptor set of the current RGB-D image 126.

With some examples, portions of logic flow 600 can be repeated without repeating the other blocks. For example, Logic flow can return from block 640 to block 310, for example, to perform localization based on another captured RGB-D image.

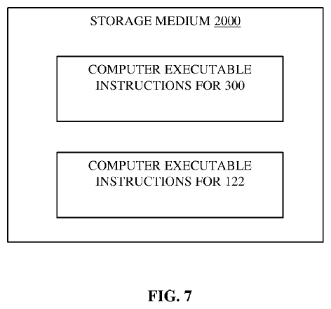

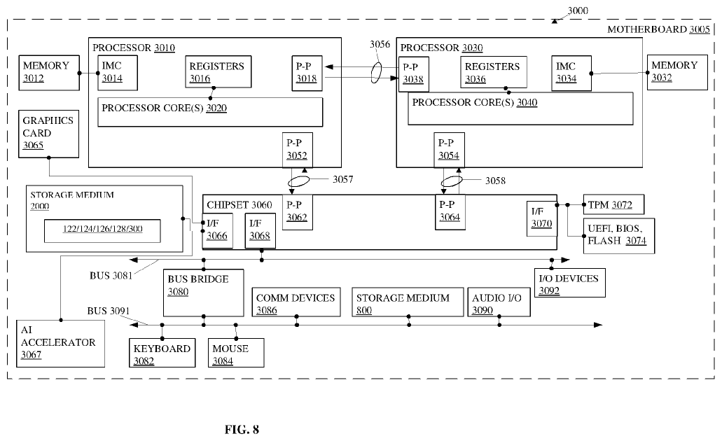

FIG. 7 illustrates an embodiment of a storage medium 2000. Storage medium 2000 may comprise any non-transitory computer-readable storage medium or machine-readable storage medium, such as an optical, magnetic or semiconductor storage medium. In various embodiments, storage medium 2000 may comprise an article of manufacture. In some embodiments, storage medium 2000 may store computer-executable instructions, such as computer-executable instructions 122 and/or instructions to implement one or more of logic flows or operations described herein, such as with respect to logic flow 300 of FIG. 3 and/or logic flow 600 of FIG. 6. Similarly, the storage medium 2000 may store computer-executable instructions for equations depicted above. The storage medium 2000 may further store computer-executable instructions for models and/or networks described herein, such as CNN 124, CNN 400, FCWB 500, or the like. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

FIG. 8 illustrates an embodiment of an exemplary computing architecture 3000 that may be suitable for implementing various embodiments as previously described. In various embodiments, the computing architecture 3000 may comprise or be implemented as part of an electronic device. In some embodiments, the computing architecture 3000 may be representative, for example, of a computer system that implements one or more components of devices 100 of FIG. 1 or system 200 of FIG. 2. The embodiments are not limited in this context. More generally, the computing architecture 3000 is configured to implement all logic, systems, logic flows, methods, equations, apparatuses, and functionality described herein and with reference to FIGS. 1-7.

FIG. 8 illustrates an embodiment of a system 3000. The system 3000 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 3000 may have a single processor with one core or more than one processor. Note that the term “processor” refers to a processor with a single core or a processor package with multiple processor cores. In at least one embodiment, the computing system 3000 is representative of the components of the device 100 of FIG. 1 or the system 200 of FIG. 2. More generally, the computing system 3000 is configured to implement all logic, systems, logic flows, methods, apparatuses, and functionality described herein with reference to FIGS. 1-7.

As used in this application, the terms “system” and “component” and “module” are intended to refer to a computer-related entity, either hardware, a combination of hardware and software, software, or software in execution, examples of which are provided by the exemplary system 3000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 3000 comprises a motherboard 3005 for mounting platform components. The motherboard 3005 is a point-to-point interconnect platform that includes a first processor 3010 and a second processor 3030 coupled via a point-to-point interconnect 3056 such as an Ultra Path Interconnect (UPI). In other embodiments, the system 3000 may be of another bus architecture, such as a multi-drop bus. Furthermore, each of processors 3010 and 3030 may be processor packages with multiple processor cores including processor core(s) 3020 and 3040, respectively. While the system 3000 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 3010 and the chipset 3060. Some platforms may include additional components and some platforms may only include sockets to mount the processors and/or the chipset.

The processors 3010, 3020 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi processor architectures may also be employed as the processors 3010, 3020.

The first processor 3010 includes an integrated memory controller (IMC) 3014 and point-to-point (P-P) interfaces 3018 and 3052. Similarly, the second processor 3030 includes an IMC 3034 and P-P interfaces 3038 and 3054. The IMC's 3014 and 3034 couple the processors 3010 and 3030, respectively, to respective memories, a memory 3012 and a memory 3032. The memories 3012 and 3032 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 3012 and 3032 locally attach to the respective processors 3010 and 3030. In other embodiments, the main memory may couple with the processors via a bus and shared memory hub.

System 3000 includes chipset 3060 coupled to processors 3010 and 3030. Furthermore, chipset 3060 can be coupled to storage 2000, for example, via an interface (I/F) 3066. The I/F 3066 may be, for example, a Peripheral Component Interconnect-enhanced (PCI-e).

The first processor 3010 couples to a chipset 3060 via P-P interconnects 3052 and 3062 and the second processor 3030 couples to a chipset 3060 via P-P interconnects 3054 and 3064. Direct Media Interfaces (DMIs) 3057 and 3058 may couple the P-P interconnects 3052 and 3062 and the P-P interconnects 3054 and 3064, respectively. The DMI may be a high-speed interconnect that facilitates, e.g., eight Giga Transfers per second (GT/s) such as DMI 3.0. In other embodiments, the processors 3010 and 3030 may interconnect via a bus.

The chipset 3060 may comprise a controller hub such as a platform controller hub (PCH). The chipset 3060 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 3060 may comprise more than one controller hub such as a chipset with a memory controller hub, a graphics controller hub, and an input/output (I/O) controller hub.

In the present embodiment, the chipset 3060 couples with a trusted platform module (TPM) 3072 and the UEFI, BIOS, Flash component 3074 via an interface (I/F) 3070. The TPM 3072 is a dedicated microcontroller designed to secure hardware by integrating cryptographic keys into devices. The UEFI, BIOS, Flash component 3074 may provide pre-boot code.

Furthermore, chipset 3060 includes the I/F 3066 to couple chipset 3060 with a high-performance graphics engine, graphics card 3065. In other embodiments, the system 3000 may include a flexible display interface (FDI) between the processors 3010 and 3030 and the chipset 3060. The FDI interconnects a graphics processor core in a processor with the chipset 3060.

Various I/O devices 3092 couple to the bus 3081, along with a bus bridge 3080 which couples the bus 3081 to a second bus 3091 and an I/F 3068 that connects the bus 3081 with the chipset 3060. In one embodiment, the second bus 3091 may be a low pin count (LPC) bus. Various devices may couple to the second bus 3091 including, for example, a keyboard 3082, a mouse 3084, communication devices 3086 and the storage medium 2000 that may store computer executable code as previously described herein. For example, storage 2000 can store instructions 122, CNN 124, current RGB-D image 126, and key RGB-D images 128.

Furthermore, an audio I/O 3090 may couple to second bus 3091. Many of the I/O devices 3092, communication devices 3086, and the storage medium 800 may reside on the motherboard 3005 while the keyboard 3082 and the mouse 3084 may be add-on peripherals. In other embodiments, some or all the I/O devices 3092, communication devices 3086, and the storage medium 800 are add-on peripherals and do not reside on the motherboard 3005.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

In addition, in the foregoing Detailed Description, various features are grouped together in a single example to streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chip set, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language, and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The following examples pertain to further embodiments, from which numerous permutations and configurations will be apparent.

Example 1. An apparatus, comprising: a processing circuitry; and memory coupled to the processing circuitry, the memory to store instructions that when executed by the processor circuit cause the processing circuitry to: receive image data comprising indications of color and depth; execute a convolutional neural network (CNN) with the image data as input, the CNN comprising a processing block disposed after the convolutional layers; extract image descriptors from the image data based output from the processing block; and identify a location based in part on the extracted image descriptors.

Example 2. The apparatus of claim 1, the instructions when executed by the processing circuity cause the processing circuitry to: receive outputs from the processing block, the outputs comprising indications of the image descriptors; scale the outputs from the processing block; and set the scaled outputs as the image descriptors.

Example 3. The apparatus of claim 1, the instructions when executed by the processing circuity cause the processing circuitry to: receive key image data for a plurality of key images, the key image data comprising indications of color and depth; execute the CNN with each of the key image data as input; extract image descriptors from each of the key image data based output from the processing block; and retrieve a scene based on matching the extracted image descriptors from one of the key image data with the extracted image descriptors from the image data.

Example 4. The apparatus of claim 3, the instructions when executed by the processing circuity cause the processing circuitry to: identify a match between the extracted image descriptors of the one of the key image data with the extracted image descriptors of the image data based in part on an Oriented FAST and Rotated BRIEF (ORB) feature matching process.

Example 5. The apparatus of claim 1, the instructions when executed by the processing circuity cause the processing circuitry to: receiving the image data from a depth camera; and encode the image data and an RGB-D image, the RGB-D image comprising indications of red, green, and blue color data and indications of depth.

Example 6. The apparatus of claim 5, the indications of depth comprising an indication of horizontal disparity, height above ground, and the angle of the local surface normal with the inferred gravity direction.

Example 7. The apparatus of claim 1, the processing block comprising a fast channel wide block (FCWB).

Example 8. The apparatus of claim 1, the FCWB comprising: a global pooling layer having 1×1×C dimensions, where C is the number of channels in the CNN; a fully connected layer having 1×1×C dimensions; and a sigmoid function layer having 1×1×C dimensions.

Example 9. A non-transitory computer-readable storage medium storing instructions which when executed by a processing circuitry cause the processing circuitry to: receive image data comprising indications of color and depth; execute a convolutional neural network (CNN) with the image data as input, the CNN comprising a processing block disposed after the convolutional layers; extract image descriptors from the image data based output from the processing block; and identify a location based in part on the extracted image descriptors.

Example 10. The non-transitory computer-readable storage medium of claim 9, storing instructions which when executed by the processing circuitry cause the processing circuitry to: receive outputs from the processing block, the outputs comprising indications of the image descriptors; scale the outputs from the processing block; and set the scaled outputs as the image descriptors.

Example 11. The non-transitory computer-readable storage medium of claim 9, storing instructions which when executed by the processing circuitry cause the processing circuitry to: receive key image data for a plurality of key images, the key image data comprising indications of color and depth; execute the CNN with each of the key image data as input; extract image descriptors from each of the key image data based output from the processing block; and retrieve a scene based on matching the extracted image descriptors from one of the key image data with the extracted image descriptors from the image data.

Example 12. The non-transitory computer-readable storage medium of claim 11, storing instructions which when executed by the processing circuitry cause the processing circuitry to: identify a match between the extracted image descriptors of the one of the key image data with the extracted image descriptors of the image data based in part on an Oriented FAST and Rotated BRIEF (ORB) feature matching process.

Example 13. The non-transitory computer-readable storage medium of claim 9, storing instructions which when executed by the processing circuitry cause the processing circuitry to: receive the image data from a depth camera; and encode the image data and an RGB-D image, the RGB-D image comprising indications of red, green, and blue color data and indications of depth.

Example 14. The non-transitory computer-readable storage medium of claim 13, the indications of depth comprising an indication of horizontal disparity, height above ground, and the angle of the local surface normal with the inferred gravity direction.

Example 15. The non-transitory computer-readable storage medium of claim 9, the processing block comprising a fast channel wide block (FCWB).

Example 16. The non-transitory computer-readable storage medium of claim 15, the FCWB comprising: a global pooling layer having 1×1×C dimensions, where C is the number of channels in the CNN; a fully connected layer having 1×1×C dimensions; and a sigmoid function layer having 1×1×C dimensions.

Example 17. A robotic system, comprising: a depth camera; a battery; a movement subsystem; processing circuitry; and memory coupled to the processing circuitry, the memory to store instructions that when executed by the processor circuit cause the processing circuitry to: receive, from the depth camera, image data comprising indications of color and depth; execute a convolutional neural network (CNN) with the image data as input, the CNN comprising a processing block disposed after the convolutional layers; extract image descriptors from the image data based output from the processing block; and identify a location based in part on the extracted image descriptors.

Example 18. The robotic system of claim 17, the instructions when executed by the processing circuity cause the processing circuitry to: receive outputs from the processing block, the outputs comprising indications of the image descriptors; scale the outputs from the processing block; and set the scaled outputs as the image descriptors.

Example 19. The robotic system of claim 17, the instructions when executed by the processing circuity cause the processing circuitry to: receive key image data for a plurality of key images, the key image data comprising indications of color and depth; execute the CNN with each of the key image data as input; extract image descriptors from each of the key image data based output from the processing block; and retrieve a scene based on matching the extracted image descriptors from one of the key image data with the extracted image descriptors from the image data.

Example 20. The robotic system of claim 19, the instructions when executed by the processing circuity cause the processing circuitry to: identify a match between the extracted image descriptors of the one of the key image data with the extracted image descriptors of the image data based in part on an Oriented FAST and Rotated BRIEF (ORB) feature matching process.

Example 21. The robotic system of claim 17, the instructions when executed by the processing circuity cause the processing circuitry to: encode the image data and an RGB-D image, the RGB-D image comprising indications of red, green, and blue color data and indications of depth.

Example 22. The robotic system of claim 21, the indications of depth comprising an indication of horizontal disparity, height above ground, and the angle of the local surface normal with the inferred gravity direction.

Example 23. The robotic system of claim 17, the processing block comprising a fast channel wide block (FCWB).

Example 24. The robotic system of claim 23, the FCWB comprising: a global pooling layer having 1×1×C dimensions, where C is the number of channels in the CNN; a fully connected layer having 1×1×C dimensions; and a sigmoid function layer having 1×1×C dimensions.

Example 25. The robotic system of claim 23, the movement subsystem comprising at least one of, wheels, rotors, tracks, motors, actuators, or gears.

Example 26. A method, comprising: receiving image data comprising indications of color and depth; executing a convolutional neural network (CNN) with the image data as input, the CNN comprising a processing block disposed after the convolutional layers; extracting image descriptors from the image data based output from the processing block; and identifying a location based in part on the extracted image descriptors.

Example 27. The method of claim 26, comprising: receiving outputs from the processing block, the outputs comprising indications of the image descriptors; scaling the outputs from the processing block; and setting the scaled outputs as the image descriptors.

Example 28. The method of claim 27, comprising: receiving key image data for a plurality of key images, the key image data comprising indications of color and depth; executing the CNN with each of the key image data as input; extracting image descriptors from each of the key image data based output from the processing block; and retrieving a scene based on matching the extracted image descriptors from one of the key image data with the extracted image descriptors from the image data.

Example 29. The method of claim 28, comprising: identifying a match between the extracted image descriptors of the one of the key image data with the extracted image descriptors of the image data based in part on an Oriented FAST and Rotated BRIEF (ORB) feature matching process.

Example 30. The method of claim 26, comprising: receiving the image data from a depth camera; and encoding the image data and an RGB-D image, the RGB-D image comprising indications of red, green, and blue color data and indications of depth.

Example 31. The method of claim 30, the indications of depth comprising an indication of horizontal disparity, height above ground, and the angle of the local surface normal with the inferred gravity direction.

Example 32. The method of claim 26, the processing block comprising a fast channel wide block (FCWB).

Example 33. The method of claim 32, the FCWB comprising: a global pooling layer having 1×1×C dimensions, where C is the number of channels in the CNN; a fully connected layer having 1×1×C dimensions; and a sigmoid function layer having 1×1×C dimensions.

Example 34. An apparatus, comprising means arranged to implement the function of any one of claims 26 to 33.

Example 35. At least one non-transitory computer-readable storage medium comprising instructions that when executed by a computing device, cause the computing device to perform the method of any one of claims 26 to 33.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1-20. (canceled)

21. An apparatus, comprising:
a processing circuitry; and
memory coupled to the processing circuitry, the memory to store instructions that when executed by the processing circuitry cause the processing circuitry to:
receive image data comprising indications of color and depth;
execute a convolutional neural network (CNN) with the image data as input, the CNN comprising a processing block disposed after the convolutional layers;
extract image descriptors from the image data based output from the processing block; and
identify a location based in part on the extracted image descriptors.

22. The apparatus of claim 21, the instructions when executed by the processing circuity cause the processing circuitry to:
receive outputs from the processing block, the outputs comprising indications of the mage descriptors;
scale the outputs from the processing block; and
set the scaled outputs as the image descriptors.

23. The apparatus of claim 21, the instructions when executed by the processing circuity cause the processing circuitry to:
receive key image data for a plurality of key images, the key image data comprising indications of color and depth;
execute the CNN with each of the key image data as input;
extract image descriptors from each of the key image data based output from the processing block; and
retrieve a scene based on matching the extracted image descriptors from one of the key image data with the extracted image descriptors from the image data.

24. The apparatus of claim 23, the instructions when executed by the processing circuity cause the processing circuitry to identify a match between the extracted image descriptors of the one of the key image data with the extracted image descriptors of the image data based in part on an Oriented FAST and Rotated BRIEF (ORB) feature matching process.

25. The apparatus of claim 21, the instructions when executed by the processing circuity cause the processing circuitry to:
receiving the image data from a depth camera; and
encode the image data and an RGB-D image, the RGB-D image comprising indications of red, green, and blue color data and indications of depth.

26. The apparatus of claim 25, the indications of depth comprising an indication of horizontal disparity, height above ground, and the angle of the local surface normal with the inferred gravity direction.

27. The apparatus of claim 21, the processing block comprising a fast channel wide block (FCWB).

28. The apparatus of claim 21, the FCWB comprising:
a global pooling layer having 1×1×C dimensions, where C is the number of channels in the CNN;
a fully connected layer having 1×1×C dimensions; and
a sigmoid function layer having 1×1×C dimensions.

29. A non-transitory computer-readable storage medium storing instructions which when executed by a processing circuitry cause the processing circuitry to:
receive image data comprising indications of color and depth;
execute a convolutional neural network (CNN) with the image data as input, the CNN comprising a processing block disposed after the convolutional layers;
extract image descriptors from the image data based output from the processing block; and
identify a location based in part on the extracted image descriptors.

30. The non-transitory computer-readable storage medium of claim 29, storing instructions which when executed by the processing circuitry cause the processing circuitry to:
receive outputs from the processing block, the outputs comprising indications of the image descriptors;
scale the outputs from the processing block; and
set the scaled outputs as the image descriptors.

31. The non-transitory computer-readable storage medium of claim 29, storing instructions which when executed by the processing circuitry cause the processing circuitry to:
receive key image data for a plurality of key images, the key image data comprising indications of color and depth;
execute the CNN with each of the key image data as input;
extract image descriptors from each of the key image data based output from the processing block; and
retrieve a scene based on matching the extracted image descriptors from one of the key image data with the extracted image descriptors from the image data.

32. The non-transitory computer-readable storage medium of claim 31, storing instructions which when executed by the processing circuitry cause the processing circuitry to identify a match between the extracted image descriptors of the one of the key image data with the extracted image descriptors of the image data based in part on an Oriented FAST and Rotated BRIEF (ORB) feature matching process.

33. The non-transitory computer-readable storage medium of claim 29, storing instructions which when executed by the processing circuitry cause the processing circuitry to:
receive the image data from a depth camera; and
encode the image data and an RGB-D image, the RGB-D image comprising indications of red, green, and blue color data and indications of depth.

34. The non-transitory computer-readable storage medium of claim 33, the indications of depth comprising an indication of horizontal disparity, height above ground, and the angle of the local surface normal with the inferred gravity direction.

35. The non-transitory computer-readable storage medium of claim 29, the processing block comprising a fast channel wide block (FCWB).

36. The non-transitory computer-readable storage medium of claim 35, the FCWB comprising:
a global pooling layer having 1×1×C dimensions, where C is the number of channels in the CNN;
a fully connected layer having 1×1×C dimensions; and
a sigmoid function layer having 1×1×C dimensions.

37. A robotic system, comprising:
a depth camera;
a battery;
a movement subsystem;
processing circuitry; and
memory coupled to the processing circuitry, the memory to store instructions that when executed by the processor circuit cause the processing circuitry to:
receive, from the depth camera, image data comprising indications of color and depth;
execute a convolutional neural network (CNN) with the image data as input, the CNN comprising a processing block disposed after the convolutional layers;
extract image descriptors from the image data based output from the processing block; and
identify a location based in part on the extracted image descriptors.

38. The robotic system of claim 37, the instructions when executed by the processing circuity cause the processing circuitry to:
receive outputs from the processing block, the outputs comprising indications of the image descriptors;
scale the outputs from the processing block; and
set the scaled outputs as the image descriptors.

39. The robotic system of claim 37, the instructions when executed by the processing circuity cause the processing circuitry to:
receive key image data for a plurality of key images, the key image data comprising indications of color and depth;
execute the CNN with each of the key image data as input;
extract image descriptors from each of the key image data based output from the processing block; and
retrieve a scene based on matching the extracted image descriptors from one of the key image data with the extracted image descriptors from the image data.

40. The robotic system of claim 39, the instructions when executed by the processing circuity cause the processing circuitry to identify a match between the extracted image descriptors of the one of the key image data with the extracted image descriptors of the image data based in part on an Oriented FAST and Rotated BRIEF (ORB) feature matching process.

41. The robotic system of claim 37, the instructions when executed by the processing circuity cause the processing circuitry to encode the image data and an RGB-D image, the RGB-D image comprising indications of red, green, and blue color data and indications of depth.

42. The robotic system of claim 37, the processing block comprising a fast channel wide block (FCWB), the FCWB comprising:
a global pooling layer having 1×1×C dimensions, where C is the number of channels in the CNN;
a fully connected layer having 1×1×C dimensions; and
a sigmoid function layer having 1×1×C dimensions.

43. A method, comprising:
receiving image data comprising indications of color and depth;
executing a convolutional neural network (CNN) with the image data as input, the CNN comprising a processing block disposed after the convolutional layers;
extracting image descriptors from the image data based output from the processing block; and
identifying a location based in part on the extracted image descriptors.

44. The method of claim 43, comprising:
receiving outputs from the processing block, the outputs comprising indications of the image descriptors;
scaling the outputs from the processing block; and
setting the scaled outputs as the image descriptors.

45. The method of claim 44, comprising:
receiving key image data for a plurality of key images, the key image data comprising indications of color and depth;
executing the CNN with each of the key image data as input;
extracting image descriptors from each of the key image data based output from the processing block; and
retrieving a scene based on matching the extracted image descriptors from one of the key image data with the extracted image descriptors from the image data.
